(19) United States
(12) Patent Application Publication
(10) Pub. No.: US 2013/0124341 A1
(43) Pub. Date: May 16, 2013

(54) Persistent content capture

(71) Applicants: Benjamin Paul Bauermeister, Seattle, WA (US); Asako Yoshimura, Seattle, WA (US)

(72) Inventors: Benjamin Paul Bauermeister, Seattle, WA (US); Asako Yoshimura, Seattle, WA (US)

(73) Assignee: Adobe Systems Incorporated, San Jose, CA (US)

(21) Appl. No.: 11/508,050

(22) Filed: Aug. 22, 2006

(51) Int. Cl. G06F 3/0486

(52) U.S. Cl. CPC G06F 3/0486; G06Q 30/0277
USPC 705/14.73

(57) ABSTRACT

Persistent content capture is described, including detecting an input associated with data presented in a first area of an environment, moving the data from the first area to a second area of the environment in response to the input, wherein moving the data generates processed data, and providing an interface element in the second area, the interface element being associated with the data and processed data, wherein the interface element is not affected by a function performed in the first area of the environment and the data and the processed data are accessed when the interface element is selected.

### FIELD OF THE INVENTION

The present invention relates generally to software applications and architecture. More specifically, persistent content capture is described.

### BACKGROUND OF THE INVENTION

Targeted online advertising and marketing provide relevant content to users while other content (e.g., an article, a video, a song, an e-commerce website, and the like) is being viewed. Advertisements (“ads”) are presented using various types of display techniques, including banner, tile, graphically-based, text-based, pop-up, or other types of layouts and sizes. However, conventional techniques for presenting ads are often transient, limited, and restrictive.

Ads are often targeted to users based on the context, types of surrounding content, time, season, context, or other factors. For example, if a user is reading an article written about a convertible automobile review performed in August, an ad server (i.e., a computer, server, or other processor-based system that is configured to send ad content for inclusion with non-advertising (e.g., editorial, news, originally-authored, and the like) content being served from the same or different servers) may present an ad for a car dealer specializing in convertible automobile sales through the dealer's website. Attracting users to view or interact with ad content often relies on the ad being relevant to the user. However, when relevant ads are presented, a user may not be inclined to view the ad immediately. A user may be engaged in other online or offline activities that could preclude her from viewing an ad when presented. For example, if a user is conducting online research and directs her web browser (e.g., Internet Explorer by Microsoft®, Firefox by Mozilla®, Netscape Navigator®, and the like) to several different addresses, indicators, uniform resource locators (URLs), uniform resource indicators (URIs), or other addresses, ads presented on a website may change if the user leaves the website or changes web pages. Further, if a given website or page remains persistent in a browser, the ads may change as the website or page is refreshed. Still further, collaborative data sharing environments do not offer the ability for users to identify content for other users to view, while remaining continuously displayed as the group changes its activities, functions, workspace, items, or other aspects of the environment.

Thus, a solution for enabling convenient viewing of content without the limitations of conventional techniques is needed.

### BRIEF DESCRIPTION OF THE DRAWINGS

Various examples are disclosed in the following detailed description and the accompanying drawings:

FIG. 1A illustrates an exemplary persistent content capture system;

FIG. 1B illustrates an alternative exemplary persistent content capture system;

FIG. 2 illustrates an exemplary persistent content capture application;

FIG. 3A illustrates an exemplary persistent content capture environment;

FIG. 3B illustrates an alternative exemplary persistent content capture environment;

FIG. 3C illustrates another exemplary persistent content capture environment;

FIG. 3D illustrates a further exemplary persistent content capture environment;

FIG. 4 is a further illustration of an exemplary persistent content capture environment;

FIG. 5A illustrates an exemplary persistent content capture process;

FIG. 5B illustrates an exemplary persistent content capture sub-process;

FIG. 6 illustrates an alternative exemplary persistent content capture sub-process; and

FIG. 7 illustrates an exemplary computer system suitable for persistent content capture.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the embodiments has not been described in detail to avoid unnecessarily obscuring the description.

Persistent content capture is described, including techniques for storing, moving, and persistently presenting content (e.g., text, image, graphic, video, audio, hyperlink (“link”), or the like) for individual, group, or collaborative uses. In some examples, content may be persistently captured and presented by an individual user. In other examples, content may be persistent captured and presented in a collaborative data sharing environment. Content (e.g., ads, text, graphics, images, video, audio, links, scripts, applets, or any other type of data associated with a given context) may be captured and persistently presented in an interface, in some examples, allowing users or members (“users”) of a group participating in a collaborative data sharing environment to perform other functions or tasks (e.g., refreshing a page, reloading a page, invoking a new or different application feature or function, and others) using other areas of a collaborative interface without modifying the presentation of captured content. Content may be captured by selecting and moving the content to a persistent content area in an environment. In some examples, a file may be generated, storing data and information associated with captured content displayed in a persistent content area. In other examples, ads (i.e., content) may be moved directly into a persistent content area, maintaining links, references, and other pointers. Persistent content capture allows one or more users to continue to use an application or otherwise work with other data while presenting selected content in a persistent manner. Persistent content capture also provides advertisers, marketers, publishers, authors, and other entities with data, information, statistics, and other metrics that may be used to determine the success of a given advertising campaign by evaluating whether an ad has been captured. The described techniques may also allow for revenue generation based on whether an ad has been captured and is being persistently presented in a collaborative data environment. In other examples, persistent content capture may be performed differently and is not limited to the examples provided. Further, the described techniques may be implemented as software, hardware, firmware, circuitry, or a combination thereof. If implemented as software, the described techniques may be implemented using various types of programming or formatting languages, formats, programming frameworks, syntax, applications, and protocols, including C, Objective C, C++, C#, Flex™, Fireworks®, Java™, Javascript™, Ajax, COBOL, Fortran, ADA, XML, HTML, DHTML, XHTML, HTTP, XMPP, and others. The types of programming or formatting languages, formats, syntax, applications, and protocols may be varied and are not limited to the examples shown or described.

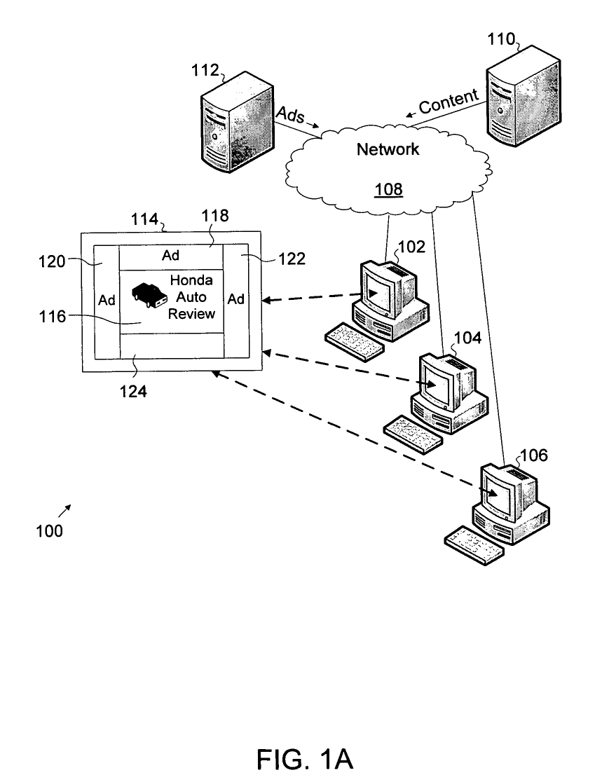

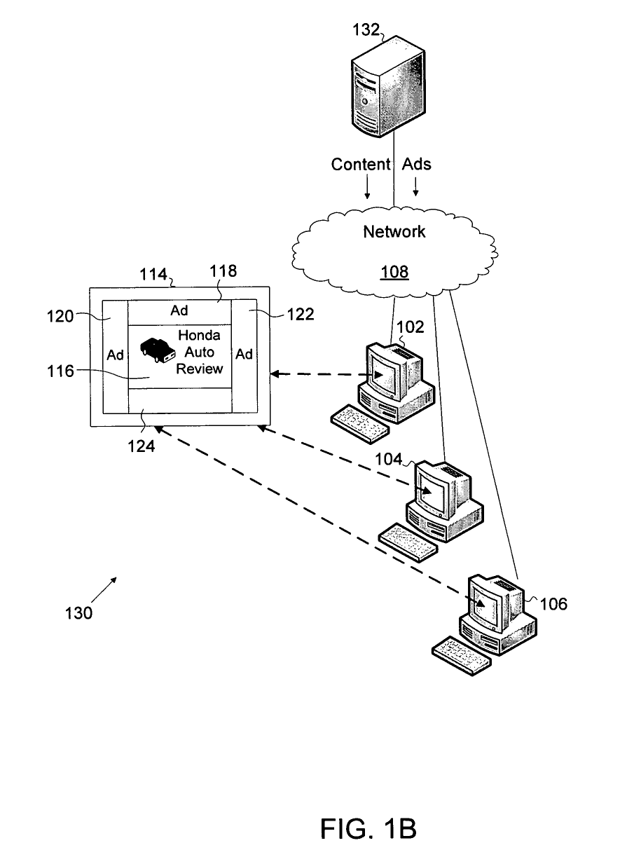

FIG. 1A illustrates an exemplary persistent content capture system. Here, system 100 includes hosts 102-106, network 108, content server 110, ad server 112, environment 114, display 116, top area 118, sidebars 120-122, and bottom area 124. In some examples, content and ads may be displayed, rendered, shown, or presented (collectively “presented”) together in environment 114, which may be an interface for a collaborative group environment shared among hosts 102-106. In other words, hosts 102-106 may be configured to collaboratively share data in environment 114 using a user interface (“interface”). Here, content server 110 and ad server 112 may deliver content and ads, respectively, to hosts 102-106 via network 108. Data (e.g., information, content, ads, and others) presented in environment 114 may be “captured” (i.e., selected, stored, and/or moved from one area to another on environment 114) and shared among hosts 102-106. When captured, data may be persistently presented, enabling hosts 102-106 to continue to view captured data (i.e., using text, graphics, icons, or other representations for the data captured) while performing other tasks and functions within environment 114. For example, if environment 114 provides a data collaboration environment for hosts 102-106 to access a set of images that are presented in display 116, ads may be presented in top bar 118 and side bars 120-122. In other examples, ads (i.e., content) may be presented in any area of environment 114. When a different function or set of images are selected for viewing in display 116, the ads in top bar 118 and side bars 120-122 may change. When an ad is presented that appeals to one or more users (i.e., hosts 102-106), the ad may be captured and moved, for example, to a persistent content area, which may be another area of environment 114 (e.g., bottom bar 124). After moving the ad, if the content, page, or other data in display 116 is changed, the ad may be persistently displayed in bottom bar 124, thus enabling a user to neither lose nor forget that an appealing ad is available for viewing at the convenience of the user. In other examples, environment 114 may be implemented differently and is not limited to the examples provided.

In some examples, system 100 may be varied in design, operation, or implementation and is not limited to the examples described. For example, content server 110 and ad server 112 may be implemented using one or more web, application, or other types of servers or processors and are not limited to the examples shown. In other examples, the number and type of elements shown in system 100 may be varied and are not limited to the examples provided. For example, more or fewer hosts may be included with hosts 102-106 and are not limited to the examples shown. Further, content and ads may be sent (i.e., “delivered”) to hosts 102-106 from content server 110 and ad server 112 over a distributed network or set of distributed networks in data communication with each other. In other examples, system 100 and the elements shown and described may be varied and are not limited to the examples provided.

FIG. 1B illustrates an alternative exemplary persistent content capture system. Here, system 130 includes hosts 102-106, network 108, content server 110, ad server 112, environment 114, display 116, top area 118, sidebars 120-122, and bottom area 124. Also shown is server 132, which may be configured to serve content and ads as a monolithic or integrated server or processor. In other words, a content, web, or application server, computer, or processor may be integrated, combined, coupled, connected directly or indirectly with another server, computer or processor to serve both content and ads. In still other examples, different network configurations and topologies and server or processor configurations may be used and are not limited to the examples shown.

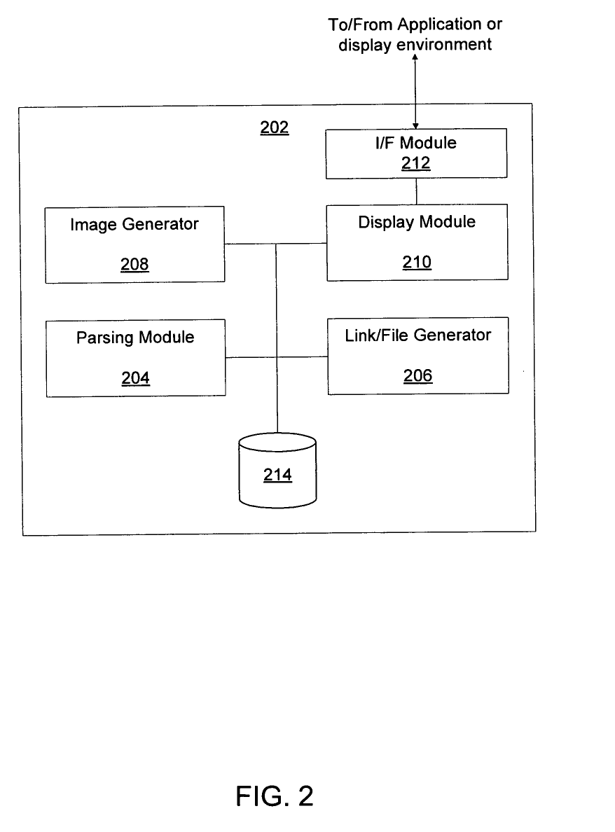

FIG. 2 illustrates an exemplary persistent content capture application. Here, application 202 includes parsing module 204, link/file generator 206, image generator 208, display module 210, interface (I/F) module 212, and storage 214. In some examples, application 202 may be implemented as a standalone (i.e., individual) application (e.g., an applet, script, or other program that may be compiled and executed separate from another application) or as part (i.e., as a module within) of another application. In other words, application 202 may be implemented as a module of functionality within another application. In other examples, application 202 may be implemented in a distributed manner (e.g., across a computing network), with some functionality being executed by one or more processors at different locations. In still other examples, application 202 may be implemented differently.

Here, parsing module 204 may be used to parse data such as an address, location, or indicator (e.g., a uniform resource locator (URL) or uniform resource indicator (URI)) sent from, for example, content server 110 (FIG. 1A), ad server 112 (FIG. 1B), server 132 (FIG. 2), or another location. In some examples, parsing module 204 may be used to parse and interpret data, such as a link, to determine if additional data may be associated with the parsed data. For example, if a hyperlink (“link”) is processed by parsing module 204, processed data yielded from parsing module 204 may indicate that additional information, text, images, video, audio, graphics, content, ads, or other resources may be found at the source of the link. Some, none, or all of this data found at the source of the link may also be captured for persistent presentation in, for example, environment 114 (FIGS. 1A-1B). In other examples, parsing module 204 may be implemented or operate differently and is not limited to the descriptions provided above.

In some examples, link/file generator 206 is used to generate a file associated with an ad or other content when an ad or content is selected and moved to another area of environment 114 (FIGS. 1A-1B) for persistent presentation. An area of environment 114 configured for persistent (i.e., continuous) presentation of content (e.g., ads) moved from another area may be referred to as a persistent content area. Further, persistent presentation may refer to the continuous presentation of content (e.g., textual content, ads, images, video, audio, and the like) in a graphical display environment when moved from an original area of presentation to another area. For example, if environment 114 includes an interface for a web browser, content that is being persistently presented remains displayed in the interface when a different page is selected. As pages are changed, functions are selected, or different applications are used from within environment 114, content may be persistently displayed in a persistent content area. As another example, if environment 114 provides a collaborative, sharing space for multiple networked (i.e., local or remotely networked) users, when content is moved to a persistent content area, users participating in the collaborative data sharing environment (i.e., environment 114) may view the captured content (i.e., content moved to a persistent content area). In some examples, user profiles may be configured to control access of some users to the captured content.

Here, once link/file generator 206 creates a file for captured content, then image generator 208 may generate an image, icon, or other element to associate with the captured content and present in the persistent content area. For example, if a text ad for a company is selected and moved to a persistent content area, parsing module 204 may parse the link and its source to retrieve a copy of the company's logo. Image generator 208 may then create a graphical image of the company's logo, but appropriately sized for the dimensions of a persistent content area, which may be any size and is not limited to any particular location, dimension, parameters, or other characteristics. Further, the graphical image of the company's logo created by image generator 208 may then be stored in the file generated by link/file generator 206. For data associated with images generated by image generator 208, content, and files generated by link file generator 206, display module 210 and interface module 212 may be used to generate, render, and display data in environment 114 (i.e., display 116, top area 118, side bars 120-122, bottom area 124, and others). In other words, data in an application (e.g., desktop, client, web browsing, collaborative data sharing, and others) may be displayed by application 202 using display module 210 and interface module 212. In other examples, application 202 and the above-described elements may be varied in design, function, and implementation and are not limited to the examples provided.

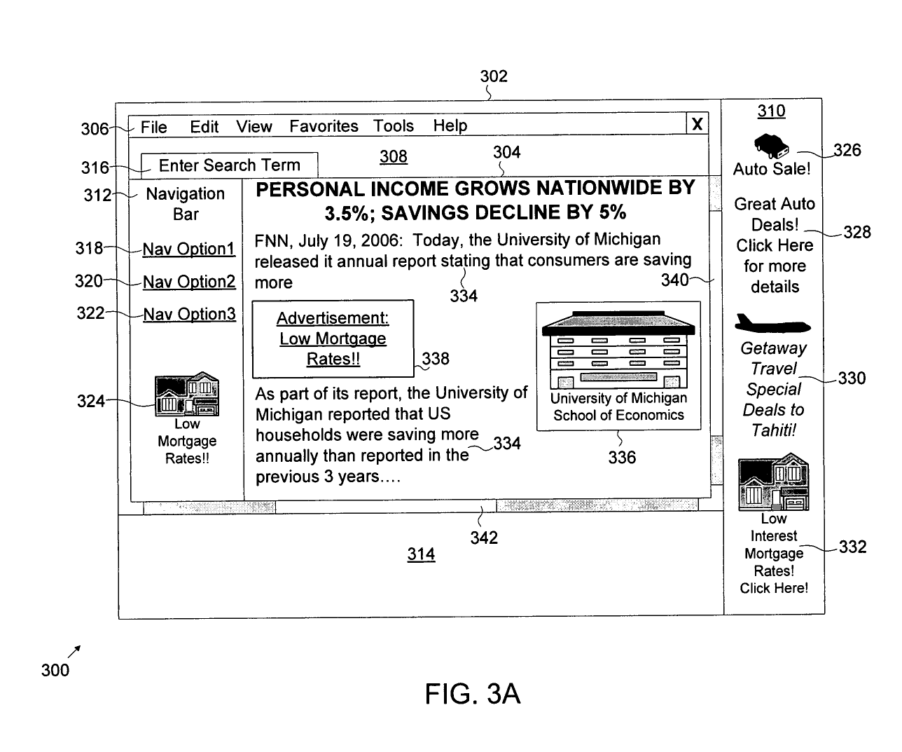

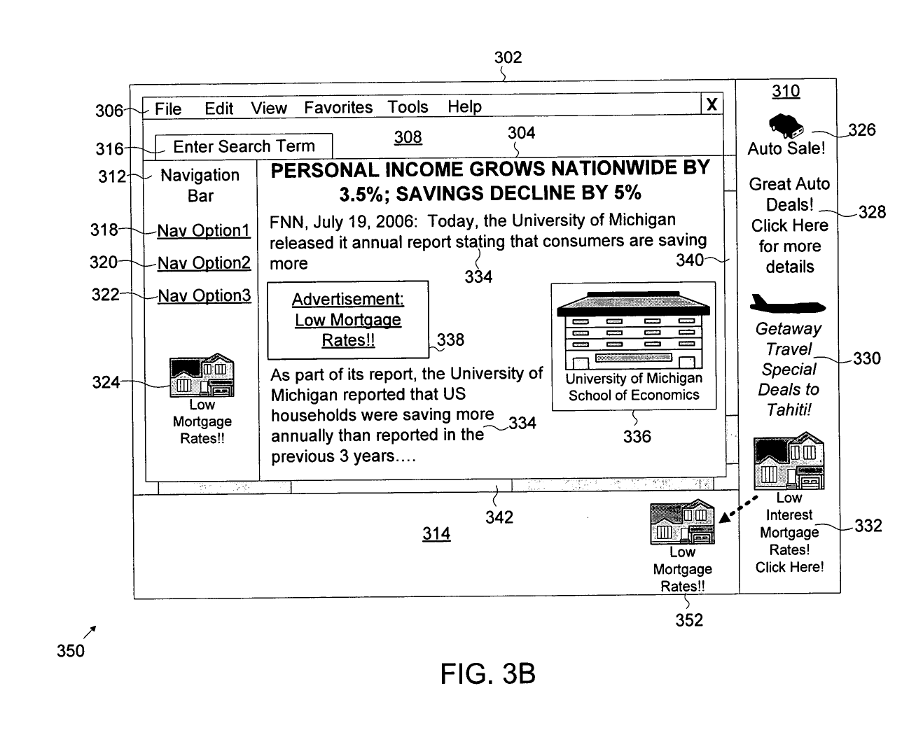

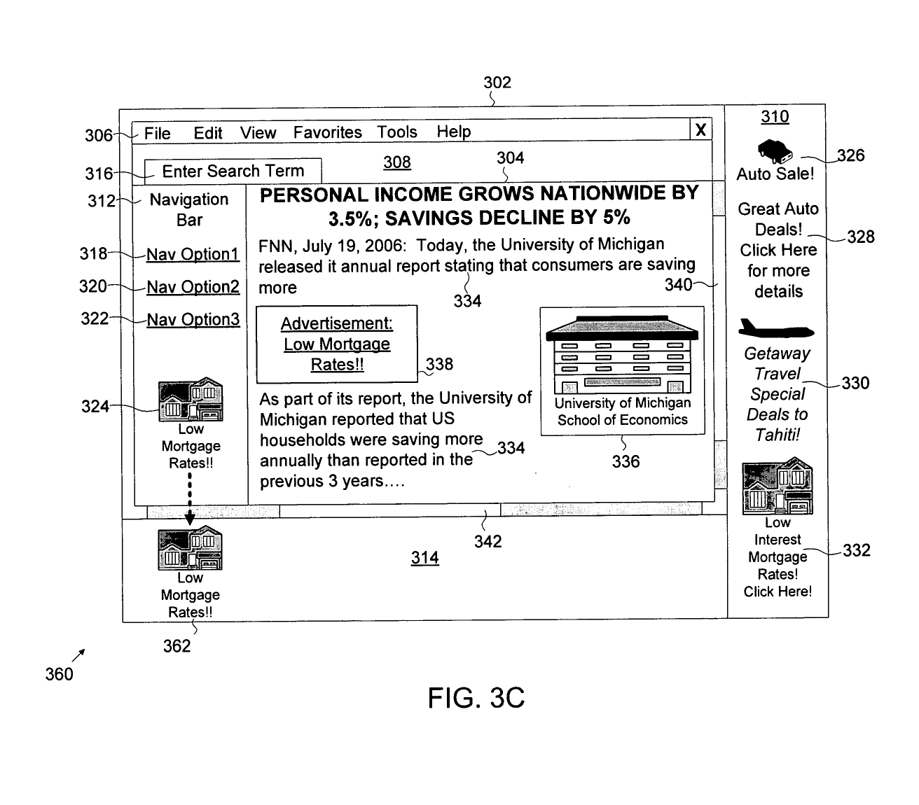

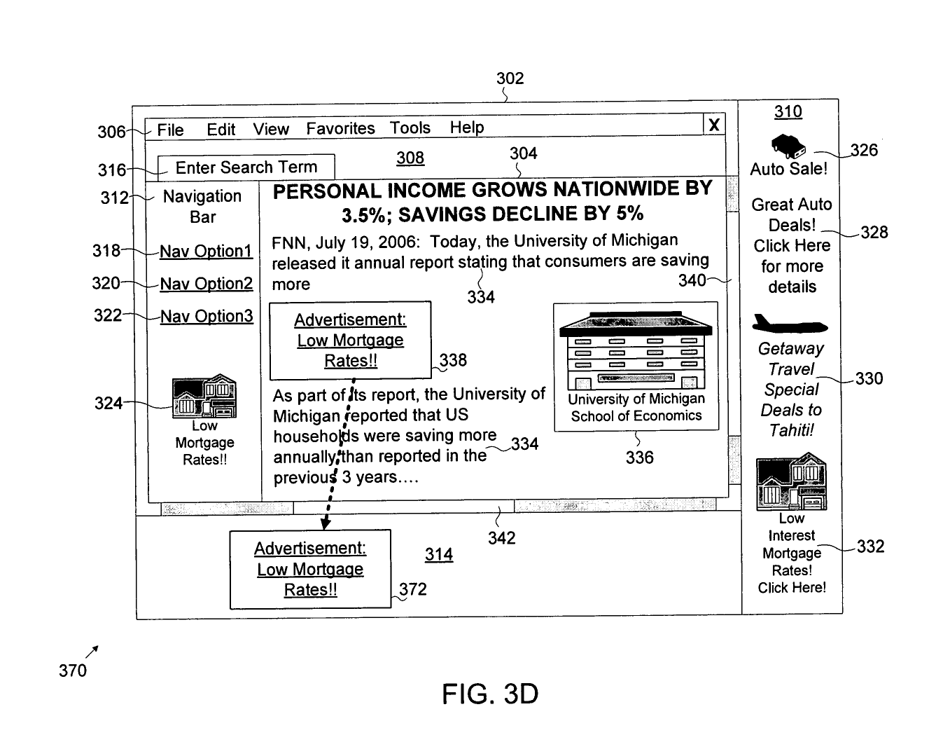

FIG. 3A illustrates an exemplary persistent content capture environment. Here, interface 300 includes environment 302, display 304, menu bar 306, top area 308, side bars 310-312, persistent content area 314, tab 316, options 318-322, ads 324-332, article 334, image 336, embedded ad 338, and slide bars 340-342. Environment 302 is shown as an example of environment 114 (FIG. 1) and more, fewer, or different elements may be implemented and are not limited to the examples provided. In some examples, content may be presented in one or more of display 304, top area 308, side bars 310-312, bottom area 314, such as article 334. Content may be an editorial or news article (e.g., “Personal Income Grows Nationwide by 3.5%; Savings Decline by 5%”), project, spreadsheet, document, image, or any other data collection that may be shared among one or more users in a collaborative data sharing environment (e.g., environment 302). In other words, content may be presented and used by a single user or by a group using a collaborative data sharing environment. Content may also include ads 324-332 and 338, which may be presented in various areas throughout environment 302, such as those described above.

Here, article 334 is presented with image 336 and embedded ad 338. Other ads (324-332) may be served in side bars 310-312. In some examples, ads 324-332 and embedded ad 338 may be contextually relevant to article 334. Ads may be delivered by ad server 112 (FIG. 1A) based on some, one, or no parameters that may be determined based on user behavior, content being served from content server 110 (FIG. 1), metadata within article 334, requests for data to be presented in environment 302, or other data that indicates how environment 302 is being used. For example, article 334 may be a financial news article about the personal income, savings, and spending of consumers. The news article may be shared among one or more users (i.e., hosts 102-106). When ads 324-332 and 338 are presented, one or more of the users may find one of them particularly interesting and select it for sharing with the other users. By selecting content presented in environment 302 and moving it (e.g., by performing a mouse click on the content and “dragging” it to persistent content area 314, or performing another type of user gesture to move the desired content (e.g., ads 324-332, embedded ad 338)) to persistent content area 314, other users are able to see the persistently presented content. Further, an individual or a group of users can continue to use environment 302, including changing the content and data in display 304, but also maintain the content that was moved to persistent content area 314. In other words, by moving content to persistent content area 314, content may be viewed, selected, “clicked on,” or otherwise accessed at a later time without interrupting other activities performed within environment 302. Persistent content area 314 enables persistent presentation of content while not restricting the use of other functions (i.e., actions, operations, programs, applications, applets, routines, sub-routines, and the like) within environment 302. Thus, an individual user or group of users are able to capture content for later viewing, access, and use without interrupting current workflow. In other examples, interface 300 and the above-described elements may be varied in design, function, and implementation and are not limited to the descriptions provided.

FIG. 3B illustrates an alternative exemplary persistent content capture environment. Here, interface 350 includes environment 302, display 304, menu bar 306, top area 308, side bars 310-312, persistent content area 314, tab 316, options 318-322, ads 324-332, article 334, image 336, embedded ad 338, and slide bars 340-342. Also shown is ad 332 that, when moved, is presented in persistent content area 314. In some examples, when ad 332 is selected, a file is created and a link contained within ad 332 is parsed. Parsing a link associated with ad 332 may access and retrieve other data and information from a source. The additional data and information may be included with the file created and associated with ad 352. In other words, when ad 352 is accessed (e.g., “clicked,” selected, and the like), a file may be opened that provides additional content, for example, in display 304. In other examples, an ad 352 and an associated link may be moved directly from side bar 310 to persistent content area 314. When moved, the image and text associated with the ad may be moved with ad 332 to persistent content area 314, appearing as an interface element (e.g., ad 352). Further, when content is moved to persistent content area 314, metrics may be collected or stored that indicate when the time and day of capture, whether the content (e.g., ad) was viewed, how many users were exposed to the captured content, and the like. These metrics (i.e., parameters, characteristics, statistics, or other data describing the performance of an ad campaign) may be used, bartered, sold, transmitted, stored, or otherwise used by various entities to establish or determine the success of a campaign. Depending upon the performance of a given ad campaign, persistent ad capture may be billed to an advertisers based on the length of capture, whether the viewing audience (e.g., the users of a collaborative data sharing environment who are viewing the persistent ad (i.e., content)) is interacting (i.e., clicking through, selecting, or the like) the ad, and the like. In other words, persistent content capture may provide techniques for establishing a billing scheme for content captured and persistently presented to users. Other billing scheme variations may be used and are not limited to the examples provided above.

In other examples, an image and an abbreviated representation of text associated with ad 332 may be moved from side bar 310 to persistent content area resulting in the presentation of an interface element with the same image but with abbreviated text, as shown with ad 352. An interface element may be an image, graphic, icon, or other visual interface element may be generated and used to represent ad 332 when moved to persistent content area 314. For example, an interface element may be a “shrunken” version of an icon in an ad. When captured, a 400 by 400 pixel icon may be reduced to generate, for example, a 200 by 200 pixel square version of the icon for use as an interface element in persistent content area 314. Other types of interface elements may also be generated. An interface element may be a visual element, image, icon, graphic, video, text, or other type of representation intended to remain continuously displayed in persistent content area 314, regardless of changes made to data, information, or content presented in other areas of environment 302. For example, if the article shown in display 304 is changed, ad 324-332 may also change to become relevant to the content shown in display 304. If persistent content capture is performed on an ad (i.e., content) and moved into persistent content area 314, it remains continuously displayed for one or more users using the collaborative data sharing application of environment 302 so that users can elect to view the ad and associated attributes (e.g., off-page or off-site link, text, video, audio, graphic, and the like) at a more convenient or desirable time. In the examples described, any type of content (e.g., ads) may be moved from various parts of environment 302 to persistent content area 314. Images, text, video, audio, graphics, and other forms and formats of media may be used with the techniques described. Interface 350 and the above-described elements may be varied in design, operation, and implementation and are not limited to the examples shown.

FIG. 3C illustrates another exemplary persistent content capture environment. Here, interface 360 is shown, including environment 302, display 304, menu bar 306, top area 308, side bars 310-312, persistent content area 314, tab 316, options 318-322, ads 324-332, article 334, image 336, embedded ad 338, and slide bars 340-342. Also shown is ad 362, which represents ad 324 when moved from side bar 312 to persistent content area 314. In some examples, content may be moved from any region or area of environment 302 to persistent content area 314. Here, side bar 312 is used to provide navigation abilities to one or more user of a collaborative data sharing environment. Other functions, features, and abilities may be presented differently using dialog, pop-up boxes, windows, menu bar 306, tabs 316, and others and are not limited to the examples provided.

Here, when content (i.e., ad 324) is selected from side bar 312, one or more users may move the ad to persistent content area 314, which allows other users (i.e., hosts 102-106 (FIG. 1A)) to view the captured content. Content may be taken from any area or portion of environment 302 and moved to persistent content area 314. When moved, content is processed to determine whether a link is present in the content indicating a source for additional (i.e., other) content. In some examples, other content may be captured and stored in a file generated for the moved content. In other examples, the content may be moved directly maintaining the link, if any, pointing to the destination indicated by the link in the original content (i.e., ad). In still other examples, when content is moved, an interface element is generated to represent the moved content. The interface element may have the same visual appearance of the original content (i.e., ad). Alternatively, an interface element may have a different visual appearance or may be generated to represent different data associated with the content selected for movement into the persistent content area 314. In other examples, interface 360, environment 302, and the above-described elements may be varied in design, function, and implementation and are not limited to the examples provided.

FIG. 3D illustrates a further exemplary persistent content capture environment. Here, interface 370 is shown, including environment 302, display 304, menu bar 306, top area 308, side bars 310-312, persistent content area 314, tab 316, options 318-322, ads 324-332, article 334, image 336, embedded ad 338, and slide bars 340-342. In some examples, content may be moved from within other content. As an example, embedded ad 338 may be moved from article 334 into persistent content area 314. Ad 372 represents embedded ad 338, which has been moved from display 304 and article 334 to persistent content area 314, as shown by the dashed line and arrow. In some examples, the visual appearance or “look-and-feel” of the captured content may be maintained and presented in persistent content area 314. In other examples, the visual appearance of captured content may be presented differently. In still other examples, interface 370 and the above-described elements may be configured differently in design, operation, and implementation and are not limited to the examples provided.

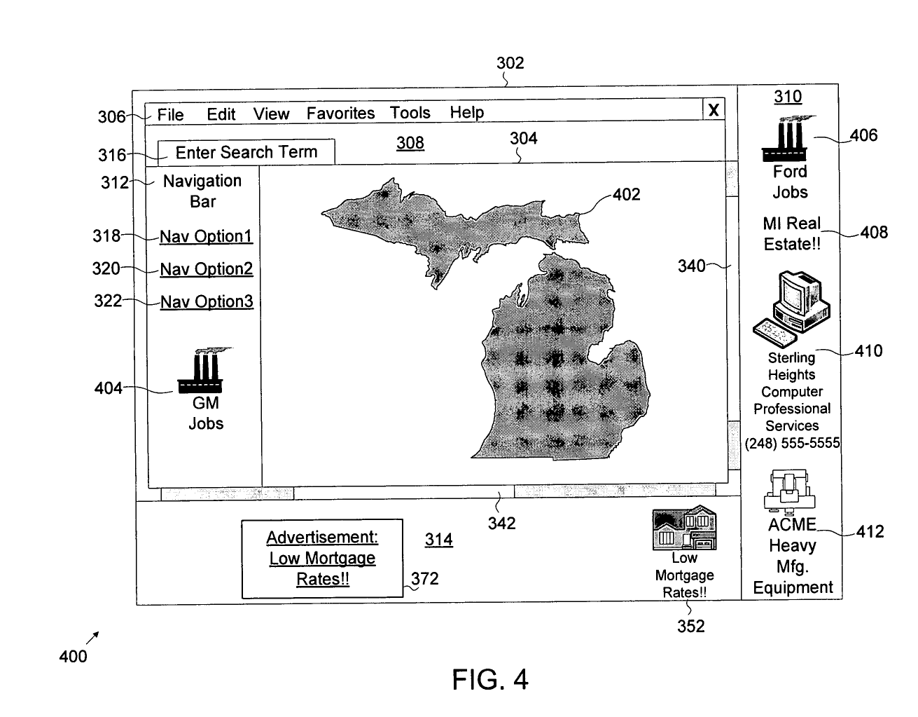

FIG. 4 is a further illustration of an exemplary persistent content capture environment. Here, interface 400 is shown including various elements that are similar to those shown and described above in FIGS. 3A-3D, including environment 302, display 304, menu bar 306, top area 308, side bars 310-312, persistent content area 314, tab 316, options 318-322, slide bars 340-342, and interface elements 352-372. In some examples, environment 302 may be a collaborative data sharing environment where one or more clients (e.g., hosts 102-106 (FIGS. 1A-1B)) are configured to access, manipulate, modify, or otherwise use a set or collection of data. Interface 400 and the elements shown may be result of further actions taken by a user in environment 302. As an example, an interactive map or representation of the state of Michigan is presented in display 304, for example, in response to a request by a user investigating article 334 (FIG. 3C) and the University of Michigan's location. In FIGS. 3A-3C, article 334 was presented, discussing consumer financial research presented by the University of Michigan. Users (i.e., hosts 102-106) may have decided to subsequently view a map of Michigan to determine where the University of Michigan (Ann Arbor) is located. In so doing, content presented in various areas of environment 302 is changed. For example, ads 404-412 are presented, demonstrating contextual and, in some examples (e.g., ad 410), geographical relevance to the content being presented in display 304. However, when ads 404-412 are presented, previous ads (e.g., ads 324-332, embedded ad 338) are replaced. For example, if a user was interested in viewing ad 324, but the content changed and new content (e.g., ads 404-412) is presented that is relevant (i.e., contextually, geographically, and the like) to the new content, the user may still view previously captured content, represented by interface elements 352 and 372, which provide access to ad 324 and embedded ad 338, respectively. Further, the captured content (i.e., the ads associated with interface elements 352 and 372), is also visible and available for interaction by other users participating in the collaborative data sharing environment 302. In other examples, interface 400 and the above-described elements may be varied in function, operation, and implementation and are not limited to the examples provided above. For example, a collaborative data sharing environment providing an empty workspace and application tool set for importing or exporting data may be implemented, such as that found in JamJar, a product developed by Adobe Systems Incorporated of San Jose, Calif. Further, any type of data sharing or collaborative work application may be used with the techniques described herein and are not limited to any particular application or program.

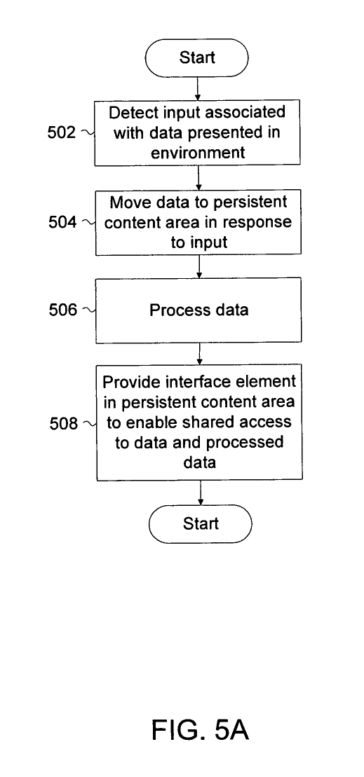

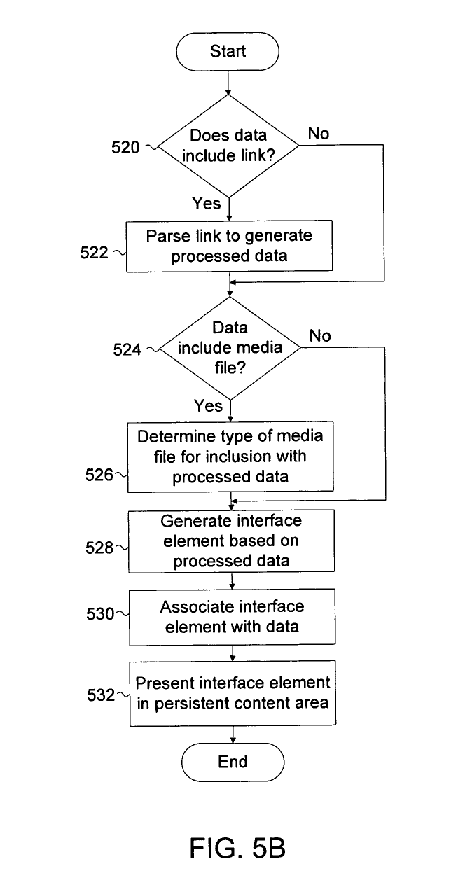

FIG. 5A illustrates an exemplary persistent content capture process. Here, an input associated with data presented in an environment (e.g., environment 302 (FIGS. 3A-3D, 4)) is detected (502). An input may be a user gesture (e.g., a mouse “click,” “click-and-drag,” “mouse over,” “roll over” or other operation) that indicates selection of a finite set of data and moving it from one area of environment 302 to another area. In response to the detected input, the selected data is moved from a first area to another area, which may be a persistent content area (e.g., persistent content area 314 (FIGS. 3A-3D, 4) within environment 302 (504). When moving the data, processing is performed. Processing may include determining whether a link is contained within the captured content (i.e., data). If a link is found, it is parsed to determine whether any additional data or content is associated with the data and whether it should be moved to a persistent content area or represented using other data that, when accessed, retrieves the original data stored at the location associated with the link (506). After processing the data moved to the persistent content area, an interface element is generated and provided in the persistent content area (508). The presentation of an interface element may be performed by generating an icon, graphic, image, thumbnail, or other visual representation associated with the captured data and content. The interface element may be presented in persistent content area 314 and used to access data, content, and processed data, if any, associated with the captured content (i.e., the content moved from a first area to a second area of an environment). In some examples, processed data may refer to data and information that is retrieved when a link is parsed to determine whether other content located at a source of the link should be retrieved and stored for later access. In other examples, processed data may refer to any data that results from application 202 (FIG. 2) processing content selected for capture and moved to persistent content area 314, including generating a file to store, retrieve, and access other associated data. As an example, an ad selected and moved (i.e., captured) to persistent content area 314 may have a file generated to store associated data resulting from application 202 processing a link embedded within the ad. An interface element generated for the ad may be a smaller or shrunken version of an image displayed with the ad before capture. Alternatively, an interface element may be generated based on an image found at the source of a link included with the ad. As yet another alternative implementation of an interface element, text may be used to instead replace an image of the ad, using an icon or other graphical element to represent a file containing data and content associated with the ad. Still further, graphical styling of persistent content (e.g., ad) may be performed based on styling information that is provided by a collaborative environment (e.g., environment 302 (FIG. 3A-3D). In other words, graphical styling of persistent content may not be based on retrieved information. Instead graphical styling may conform captured content to the “look-and-feel” of a current display, providing a contextual link to other content, features, functionality, or interface elements presented within environment 302. In still other examples, different techniques may be used to generate and implement interface elements. The above-described process may be varied and is not limited to the processes or descriptions provided.

FIG. 5B illustrates an exemplary persistent content capture sub-process. Here, when content intended for capture is processed, the following process may be used. A determination may be made to determine whether the content (i.e., data) selected for movement to a persistent content area (e.g., persistent content area 314 (FIG. 3A-3D, 4) includes a link (520). If a determination is made that a link is present, then the link is parsed to generate processed data (522). After parsing the link, or if no link is present, another determination is made as to whether the data selected for movement to a persistent content area includes a media file (524). If a media file is found, then another determination is made as to the type of media file found, which is included with the generated data (526). In some examples, several types of media files may be found, including graphics, images, digital photographs, video, audio, mixed (i.e., video and audio, images and audio, and the like), text, and others. Media files may be of any type and, if found, the type of media file and, in some examples, the media file may also be stored in a file generated and associated with the captured content. After determining the type of media file and modifying a file associated with the captured content, or if no media file is found, then an interface element is generated based on the processed data (528). If no media file is found, an interface element may be generated using the captured content (e.g., copying the captured content, generating an image using one found in the captured content, using the same icon as that representing the captured content, and the like). If a media file is found, then data extracted from the media file or by using the media file itself, an interface element may be generated. After generation, the interface element is associated with the data (i.e., content) (530) and presented in persistent content area 314. In other examples, the above-described process may be varied and is not limited to the description provided above.

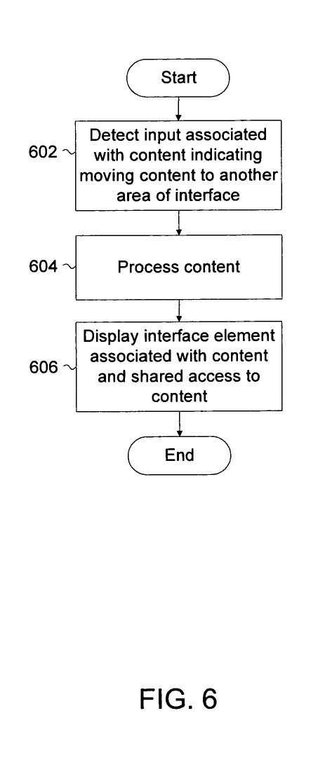

FIG. 6 illustrates an alternative exemplary persistent content capture sub-process. Here, another process for content capture is provided, including detecting an input associated with content indicating movement of the content from an area of an interface to another area of an interface (i.e., environment) (602). After detecting an input for moving the content, data associated with the content is processed (604). In some examples, processing data associated with content may be performed using techniques such as those described above. In other examples, processing data associated with content may be performed differently and is not limited to the techniques described above. After processing the content selected for movement from an area of an interface to another area of an interface, an interface element may be generated and presented in a persistent content area (e.g., persistent content area 314 (FIGS. 3A-3D, 4) (606). Simultaneously or substantially simultaneously with moving the selected content from one area to another area of the interface, shared access may also be enabled, allowing one or more users of a collaborative data sharing environment to access content using an interface element. In other examples, the above-described process may be varied and is not limited to the description provided.

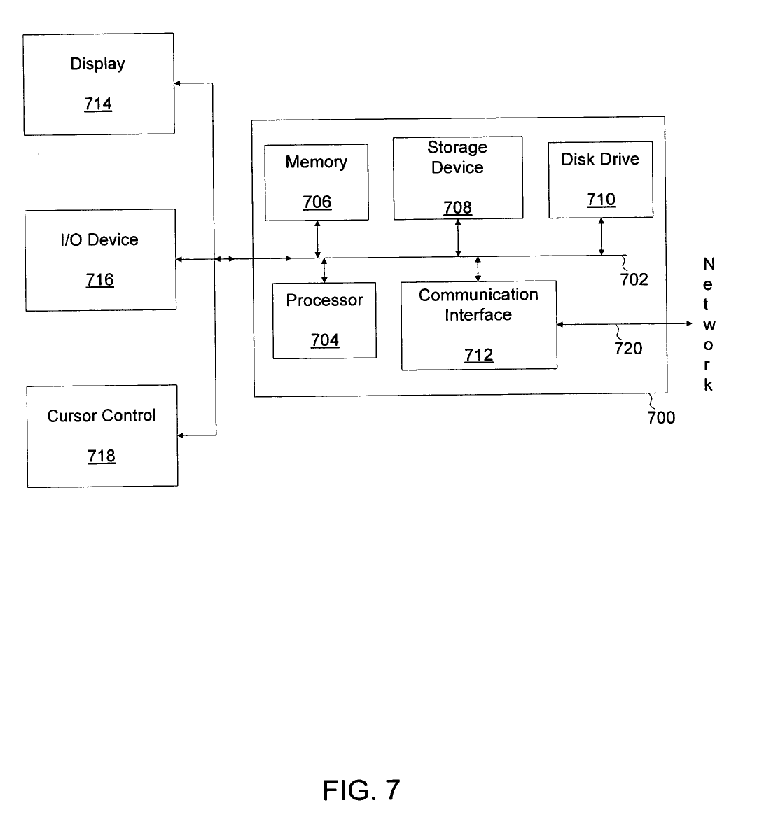

FIG. 7 illustrates an exemplary computer system suitable for persistent content capture. In some examples, computer system 700 may be used to implement computer programs, applications, methods, processes, or other software to perform the above-described techniques. Computer system 700 includes a bus 702 or other communication mechanism for communicating information, which interconnects subsystems and devices, such as processor 704, system memory 706 (e.g., RAM), storage device 708 (e.g., ROM), disk drive 710 (e.g., magnetic or optical), communication interface 712 (e.g., modem or Ethernet card), display 714 (e.g., CRT or LCD), input device 716 (e.g., keyboard), and cursor control 718 (e.g., mouse or trackball).

According to some examples, computer system 700 performs specific operations by processor 704 executing one or more sequences of one or more instructions stored in system memory 706. Such instructions may be read into system memory 706 from another computer readable medium, such as static storage device 708 or disk drive 710. In some examples, hard-wired circuitry may be used in place of or in combination with software instructions for implementation.

The term “computer readable medium” refers to any medium that participates in providing instructions to processor 704 for execution. Such a medium may take many forms, including but not limited to, non-volatile media, volatile media, and transmission media. Non-volatile media includes, for example, optical or magnetic disks, such as disk drive 710. Volatile media includes dynamic memory, such as system memory 706. Transmission media includes coaxial cables, copper wire, and fiber optics, including wires that comprise bus 702. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions may be performed by a single computer system 700. According to some examples, two or more computer systems 700 coupled by communication link 720 (e.g., LAN, PSTN, or wireless network) may perform the sequence of instructions in coordination with one another. Computer system 700 may transmit and receive messages, data, and instructions, including program, i.e., application code, through communication link 720 and communication interface 712. Received program code may be executed by processor 704 as it is received, and/or stored in disk drive 710, or other non-volatile storage for later execution.

The foregoing examples have been described in some detail for purposes of clarity of understanding, but are not limited to the details provided. There are many alternative ways and techniques for implementation. The disclosed examples are illustrative and not restrictive.

1. A method, comprising:
displaying content in a primary content area of a graphical user interface, wherein the content includes a first instance of a graphical advertisement hyperlinked to a remote resource;
detecting a user-generated input indicating the first instance of the graphical advertisement;
in response to the input, displaying a second instance of the graphical advertisement in a persistent content capture area of the graphical user interface, the second instance also being hyperlinked to the remote resource, wherein the content and the second instance are concurrently displayed in the graphical user interface; and
persistently displaying the second instance of the graphical advertisement in the persistent content capture area, such that the second instance remains displayed and hyperlinked to the remote resource, even when the content is no longer displayed in the primary content area.

2. The method recited in claim 1, further comprising in response to detecting the user-generated input, generating and storing a file comprising the graphical advertisement.

3. The method recited in claim 1, wherein the the primary content area or the persistent content capture area are concurrently presented to multiple users on different computers.

4. The method of claim 1, wherein the user interface is presented in a network browser.

5. The method of claim 1, wherein the persistent content capture area is a side bar.

6. The method of claim 1, wherein the persistent content capture area is a region of a web page.

7. The method of claim 1, wherein the second instance of the graphical advertisement is of a different size than the first instance.

8. The method of claim 1, wherein the first and second instances of the graphical advertisement are hyperlinked to the remote resource using a uniform resource locator identifying a location of the remote resource.

9. The method of claim 1, wherein the graphical advertisement comprises audio or video media.

10. (canceled)

11. (canceled)

12. (canceled)

13. The method of claim 1, wherein the user-generated input indicates dragging the first instance of the graphical advertisement from the primary content area to the persistent content capture area.

14. The method of claim 1, wherein the user interface is configured for one or more functions that, when performed, affect the content displayed in the primary content area but do not affect the second instance of the graphical advertisement.

15. A method, comprising:
detecting a user-generated input associated with a first instance of a graphical advertisement within content presented in a graphical user interface display, wherein the first instance of the graphical advertisement is hyperlinked to a remote resource, the input indicating moving the first instance of the graphical advertisement from a primary content area of the user interface to a persistent content capture area of the user interface display;
in response to the input:
processing the input, said processing including storing an indication of the input; and
displaying a second instance of the graphical advertisement in the persistent content capture area of the user interface, the second instance being hyperlinked to the remote resource and being persistently presented so that the second instance remains displayed and the remote resource remains accessible after the content is no longer presented in the primary content area of the user interface.

16. The method recited in claim 15, wherein processing the input further comprises identifying the remote resource.

17. The method recited in claim 16, wherein said processing the input further comprises storing the remote resource.

18. The method of claim 15, wherein processing the input further comprises storing the graphical advertisement and the remote resource.

19. The method of claim 18, wherein the stored graphical advertisement and the stored remote resource are accessed using the second instance of the graphical advertisement displayed in the persistent content capture area.

20. A system, comprising:
one or more processors;
a memory coupled to the processors and storing program instructions executable by the processors to implement:
displaying content in a primary content area of a graphical user interface, wherein the content includes a first instance of a graphical advertisement hyperlinked to a remote resource;
detecting a user-generated input indicating the first instance of the graphical advertisement;
in response to the input, displaying a second instance of the graphical advertisement in a persistent content capture area of the graphical user interface, the second instance also being hyperlinked to the remote resource, wherein the content and the second instance are concurrently displayed in the graphical user interface; and
persistently displaying the second instance of the graphical advertisement in the persistent content capture area, such that the second instance remains displayed and hyperlinked to the remote resource, even when the content is no longer displayed in the primary content area.

21. (canceled)

22. The system of claim 20, wherein the one or more processors are configured in a network to execute the program instructions.

23. A system, comprising:
one or more processors;
a memory coupled to the one or more processors storing program instructions executable by the processor to implement:
displaying content in a primary content area of a graphical user interface of a software application, wherein the content includes a first instance of a graphical advertisement hyperlinked to a remote resource and usable within the graphical user interface to access the remote resource;
detecting a user-generated input associated with the first instance of the graphical advertisement, the input indicating dragging the graphical advertisement from the primary content area to persistent content capture area of the graphical user interface, and in response:
processing the input, said processing including storing an indication of the input; and
displaying a second instance of the graphical advertisement, the second instance being:
displayed in the persistent content capture area of the user interface;
hyperlinked to the remote resource and usable to access the remote resource; and
persistently presented so that the second instance of the graphical advertisement remains displayed and the remote resource remains accessible after the content is no longer presented in the primary content area of the graphical user interface.

24. (canceled)

25. The system of claim 23, wherein the program instructions are executable over a data network.

26. The system of claim 20, wherein the one or more processors are distributed among one or more data networks.

27. A computer readable storage medium storing computer instructions for:
displaying content in a primary content area of a graphical user interface, wherein the content includes a first instance of a graphical advertisement hyperlinked to a remote resource;
detecting a user-generated input indicating the first instance of the graphical advertisement;
in response to the input, displaying a second instance of the graphical advertisement in a persistent content capture area of the graphical user interface, the second instance also being hyperlinked to the remote resource, wherein the content and the second instance are concurrently displayed in the graphical user interface; and
persistently displaying the second instance of the graphical advertisement in the persistent content capture area, such that the second instance remains displayed and hyperlinked to the remote resource, even when the content is no longer displayed in the primary content area.

28. A computer readable storage medium storing computer instructions for:
detecting a user-generated input associated with a first instance of a graphical advertisement within content presented in a graphical user interface display, wherein the first instance of the graphical advertisement is hyperlinked to a remote resource, the input indicating moving the first instance of the graphical advertisement from a primary content area of the user interface to a persistent content capture area of the user interface display;
in response to the input:
processing the input, said processing including storing an indication of the input; and
displaying a second instance of the graphical advertisement in the persistent content capture area of the user interface, the second instance being hyperlinked to the remote resource and being persistently presented so that the second instance remains displayed and the remote resource remains accessible after the content is no longer presented in the primary content area of the user interface.
